(19) United States
(12) Patent Application Publication
(10) Pub. No.: US 2005/0143938 A1
(43) Pub. Date: Jun. 30, 2005

(54) Method and device for determining the aerodynamic wall shear stresses on the surface of a body around wich air flows

(75) Inventors: Bernd Schulze, Taufkirchen (DE); Ole Trinks, Munich (DE)

Correspondence Address: GREENBLUM & BERNSTEIN, P.L.C., 1950 ROLAND CLARKE PLACE, RESTON, VA, 20191, US

(73) Assignee: EADS Deutschland GmbH, Ottobrunn (DE)

(21) Appl. No.: 11/003,376

(22) Filed: Dec. 6, 2004

Related U.S. Application Data
(63) Continuation of application No. PCT/DE03/01797, filed on Jun. 3, 2003.

(30) Foreign Application Priority Data
Jun. 7, 2002 (DE) 102 25 616.0

(51) Int. Cl. G01L 1/00

(52) U.S. Cl. 702/42

(57) ABSTRACT

A method for determining a wall shear stress distribution on a surface of a body around which air flows. The method includes determining a heat flow distribution into the surface of the body around which air flows by infrared thermography, obtaining a surface pressure distribution on the surface optically and determining the wall shear stress distribution on the surface of the body by processing from at least the heat flow distribution and the surface pressure distribution. The instant abstract is neither intended to define the invention disclosed in this specification nor intended to limit the scope of the invention in any way.

### CROSS-REFERENCE TO RELATED APPLICATIONS

The present application is a Continuation of International Application No. PCT/DE03/01797, filed on Jun. 3, 2003 and claims priority of German Patent Application No. DE 102 25 616.0, filed on Jun. 7, 2002. Moreover, the disclosure of International Patent Application No. PCT/DE03101797, filed on Jun. 3, 2003 is expressly incorporated by reference herein in its entirety.

### BACKGROUND OF THE INVENTION

1. Field of the Invention

The invention relates to a method and a device for determining the aerodynamic wall shear stresses on the surface of a body around which air flows.

2. Discussion of Background Information

Methods and devices for determining aerodynamic wall shear stresses on the surface of a body around which air flows are known from the general prior art, in which methods and devices these are determined optically by oil-paint methods or pressure sensitive paint (PSP) layers, whereby the luminophore was “washed out” of the layer during the test. The disadvantage of these methods and devices is that these methods only allow results by making wall shear stresses visible and, furthermore, are not applicable continuously. This means that the wind tunnel must be shut down and the model must be newly coated after the measurement has been carried out for a certain flow condition and a certain model configuration (angle of incidence of the body around which air flows, etc.).

From DE 41 34 313 C2, an infrared measuring method is known for contactless non-reactive temperature determination in a surface-sided subzone of a body through which heat flows by heat conduction. The infrared radiation emanating from the body surface is measured, and the surface temperature is determined therefrom, taking into account the emission conditions. In the surface-sided subzone the body is spectral-selective, i.e., in a first infrared wavelength range the body is radiation-absorbing and in a second infrared wavelength range, delimited from the first, it is radiation-transparent, but on the inside of the subzone it is embodied radiation-emittingly. The radiation energy emanating from the outer surface of the subzone is measured separately in the first and in the second wavelength range. The temperature on the outer surface of the subzone is determined according to the energy proportion in the first wavelength range, and the temperature on the inner surface of the subzone is determined according to the energy proportion in the second wavelength range. The local heat flow density is determined via the thickness of the surface-forming subzone.

From DE 41 34 313 C2, an infrared measuring method is known for contactless non-reactive temperature determination in a surface-sided subzone of a body through which heat flows by heat conduction. Thereby the infrared radiation emanating from the body surface is measured, and the surface temperature is determined therefrom, taking into account the emission conditions. In the surface-sided subzone the body through which heat flows is spectral-selective, in a first infrared wavelength range radiation-absorbing and in a second infrared wavelength range, delimited from the first, radiation-transparent, but on the inside of the subzone it is embodied radiation-emittingly. The radiation energy emanating from the outer surface of the subzone is measured separately in the first and in the second wavelength range, respectively, and the temperature on the outer surface of the subzone is determined according to the energy proportion in the first, and the temperature on the inner surface of the subzone is determined according to the energy proportion in the second wavelength range.

From WO 96/41142 A1, a pressure-sensitive paint is known, which is applied to a surface over which a pressure distribution is to be measured.

From U.S. Pat. No. 5,963,310 A, a measuring device is known for determining the surface friction on a body that is exposed to a flow. With this measuring device, two-dimensional wall shear stress vectors can be determined on the basis of a three-dimensional flow.

From U.S. Pat. No. 5,438,879 A, a method is known with which the surface tension magnitude and direction on a surface can be determined. Thereby a pressure-sensitive liquid crystal coating is used, which is illuminated by white light. By a video camera, the color of the liquid crystal is determined at a certain angle. The magnitude and direction of the shear stress are determined from this color information.

From DE 35 14 801 C2, a method is known for determining the wall shear stress on models and other bodies around which air flows. Thereby a viscous transparent liquid is applied in one layer on the surface of the body at the measuring point, and the change in thickness and/or surface inclination of the layer occurring as a consequence of the flow conditions is detected with a light beam. The light beam is guided from the inside of the body around which air flows in the direction of the surface of the body and into the layer of viscous liquid, and the reflected light beam is intercepted inside the body around which air flows and then further processed in terms of interference phenomena or impact point.

### SUMMARY OF THE INVENTION

An aspect of the present invention is to provide a method and a device for determining the wall shear stresses on the surface of a body around which air flows, in which method or device the distribution of wall shear stress on the surface of a body around which air flows is determined by contactless or non-reactive measuring techniques in a reversible and laminar manner.

In reversible and laminar methods and devices, the wall shear stress measurements for different measuring points and measurement series are carried out in a continuous and surface-covering manner. This means in particular that the wall shear stress measurements for different measuring points and measurement series take place without having to shut down the wind tunnel between individual measuring points to carry out applications on the model.

According to the invention, the infrared thermography (IRT) and the optical pressure measuring technique (PSP) are applied simultaneously or quasi-simultaneously to determine pressure and wall shear stress distributions in a surface-covering manner on scaled airplane models in wind tunnel testing. Pressure- and friction-related quantitative measurement data can thus be supplied without instrumentation complexities for application cases or projects and can be used for the further development of aerodynamic calculation methods.

The combination of infrared thermography methods (IRT) and methods of the optical pressure measuring technique (PSP) makes it possible to determine wall shear stresses continuously during the running test via the Reynolds analogy. Furthermore, the PSP pressure image can be corrected by the temperature information (IR camera). According to the invention, a combination of both measuring techniques (IR and PSP) via the Reynolds analogy is provided. According to the invention, the wall shear stress is determined indirectly via a heat flow from the model to the fluid and vice versa. By applying the inventive measuring method, it is possible to determine the local speed at the model in addition to the local heat flow and, by an extended Reynolds analogy, to metrologically determine the wall shear stress also on three-dimensional wind tunnel models.

One aspect of the invention includes a method for determining a wall shear stress distribution on a surface of a body around which air flows. The method includes determining a heat flow distribution into the surface of the body around which air flows by infrared thermography, obtaining a surface pressure distribution on the surface optically and determining the wall shear stress distribution on the surface of the body by processing from at least the heat flow distribution and the surface pressure distribution.

A further aspect of the invention can include determining the heat flow distribution with an infrared system, and determining the wall shear stress distribution can include determining the wall shear stress distribution with a processor. Moreover, recording a surface pressure distribution can include determining a surface pressure distribution by an optical pressure measuring technique with a PSP system, and determining the wall shear stress distribution can include determining the wall shear stress distribution with a processor. Furthermore, the heat flow distribution and the surface pressure distribution can be determined one of concurrently and consecutively. Additionally, determining the heat flow distribution can include determining the heat flow distribution with an infrared system; and recording a surface pressure distribution can include determining a surface pressure distribution with a PSP system. Moreover, a device that determines a wall shear stress distribution on a surface of a body around which air flows with a PSP system and an IR system can use the above-noted method, where a surface pressure distribution on the surface of the body around which air flows can be determined with the PSP system and the temperature distribution on the surface can be determined with the IR system one of simultaneously and consecutively. Furthermore, a device that determines a wall shear stress distribution on a surface of a body around which air flows with a PSP system and an IR system can use the above-noted method.

In yet another aspect of the invention, a device for determining a wall shear stress distribution on a surface of a body around which air flows includes a PSP system that determines a surface pressure distribution on the surface of the body around which air flows, an IR system that determines a temperature distribution on the surface of the body, the IR system, having a filter, structured and arranged to record the temperature distribution in at least two different spectral emission ranges, and a synchronizer that controls the timing of data recording of the PSP system and the IR system. The device includes a processor that determines a current distribution of a local speed of a fluid or wall shear stress at the surface of the body.

In a further aspect of the invention, the surface pressure distribution on the surface of the body around which air flows can be determined with the PSP system and the temperature distribution on the surface can be determined with the IR system one of simultaneously and consecutively.

Yet another aspect of the invention includes a method for determining an aerodynamic wall shear stress in a measuring zone of a surface of a body around which a flow medium flows includes determining a first temperature on the surface of a measuring layer and a second temperature on a surface covered by the measuring layer, determining a distribution of a heat flow q_{w} over the measuring zone on a basis of the first and second temperatures, a thickness of the measuring zone, and a heat conductivity λ_{M} of the measuring layer, and determining a surface pressure distribution and, therefrom, determining a speed of the flow medium at a margin of a boundary layer by a pressure-measurement camera system utilizing a pressure sensitivity of the measuring layer. The method further includes determining the aerodynamic wall shear stress in the measuring zone via a calculation method on the basis of the Reynolds analogy.

A further aspect of the invention includes the measuring layer can be arranged in an area of the measuring zone, the layer being thermally transparent in a first IR wavelength range and absorbs heat in a second IR wavelength range, and the first temperature and the second temperature can be radiometrically measurable by an infrared-camera measuring system. Furthermore, the measuring layer can be pressure-sensitive. Additionally, a device that determines a wall shear stress distribution on a surface of a body around which air flows with a PSP system and an IR system can use the above-noted method.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a functional representation of the device according to the invention; and

FIG. 2 shows a section through a surface-near area of the body with a measuring layer.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

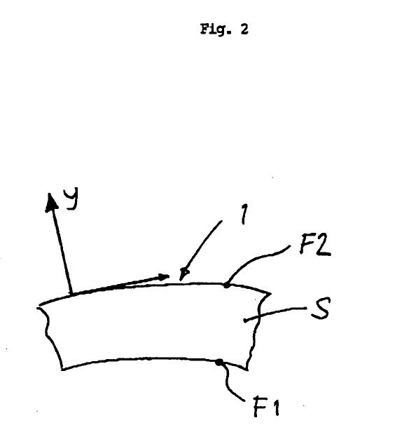

According to the invention, physical state parameters are determined, in particular the wall shear stress and the heat flow or the temperature distribution on a surface 1 or a zone 1a of a body K around which air flows. In the area of the measuring zone 1a, the body K is provided with a measuring layer S that is arranged on the surface 1, which layer allows the use according to the invention of both the provided pressure measuring method and the infrared thermography method. In a u-y coordinate system (FIG. 2) in which the coordinate y runs crosswise to the flow direction and is perpendicular to the surface 1, and U points in the flow direction, two reference surfaces F1, F2 arise from a metrological point of view, which are distanced from one another in the y direction. The first reference surface F1 is identical with the surface of the body itself, whereas the second reference surface F2 is formed by the surface of the measuring layer S in the area of the respective measuring zone 1a. The first reference surface F1 may also be referred to as substrate surface, and the second reference surface F2 as wall surface.

According to the invention, an infrared measuring system 2 is used to determine the heat flow into the surface 1 of the body around which air flows, i.e., through the measuring layer at a local point of a zone 1a or the distribution of the heat flow over the surface 1 or F1 or F2, respectively. The determination of the distribution of the heat flow over the surface 1 in the zone 1a is carried out by determining the respective temperature distribution over the first surface or wall surface F1 and the second reference surface or measuring layer surface F2. The heat flow distribution or temperature distributions and surface pressure distribution can take place according to the invention in a measuring process with the same measuring configuration. By a processor unit 4 and a synchronization unit 6, the measurement and determination of the values of heat flow distribution or temperature distribution and surface pressure distribution can take place at the same time, i.e., simultaneously, or quasi-simultaneously or also in directly or nearly consecutive iteration steps, whereby the time period for the determination of these values must be within a time frame in which a predetermined accuracy of the determined values is guaranteed.

The heat flow is determined via an infrared measuring system 2. The surface pressure distribution on the surface 1 of the body around which air flows is recorded by a PSP system 3 or a pressure measuring system. The wall shear stress distribution on the surface 1 of the body around which air flows is determined via a processor unit 4 from the simultaneously determined heat flow distribution or temperature distribution and surface pressure distribution.

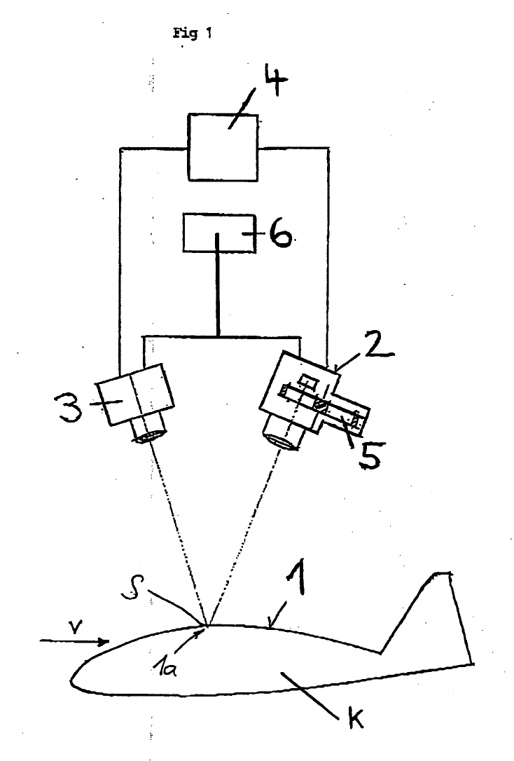

The device according to the invention, represented in FIG. 1, for determining aerodynamic wall shear stress distribution via the determination of heat flow distribution or temperature distribution and surface pressure distribution on the surface 1 of a body around which air flows shows the pressure measuring system 3 for determining the surface pressure distribution on the surface 1 of the body around which air flows and the infrared measuring system (IR system) 2 for determining the heat flow distribution or temperature distribution on the surface 1 of the body around which air flows. The IR system 2 features a filter device 5, with which the temperature distribution can be recorded in at least two predetermined, different spectral emission ranges. Furthermore. FIG. 1 shows the synchronization unit 6 for the timing control of data recording, to determine the current distribution of the physical values to be determined, pressure and temperature, in a given time interval.

The measuring method according to the invention for determining wall shear stresses is a simultaneous, multi-spectral measuring method that operates in the visible and infrared wavelength range. The wall shear stresses are determined through the local heat flow on the surface of the model around which air flows by a two-channel infrared camera system that is adapted to the absorptive and the transmissive area of the layer S, which forms a pressure-sensitive coating. The temperature distributions on and below the layer can thus be measured and the heat flow can be determined, taking into account the layer thickness and the heat conductivity of the material. The local wall shear stress is then determined from the heat flow or the heat transmission coefficient and the local pressure coefficient or the local speed via the Reynolds analogy.

Hereby, advantage is taken of the fact that the measuring layer S is suited for both the use of the pressure measuring method and the use of the IR measuring method for determining the temperature distributions on the surfaces F1, F2 or the corresponding heat flow distribution. According to the invention, the local heat flows in the surface layer are recorded by the infrared thermography and the corresponding surface pressures are recorded by the spectroscopic pressure measuring technique in the same measuring process (i.e., with the same measuring arrangement) via a camera-supported method. The two measuring parameters are linked via the so-called Reynolds analogy to the aerodynamic wall shear stress.

For calculating the aerodynamic wall shear stresses by processor unit 4, the measuring parameters
coating thickness d;
surface temperature T_{w};
substrate temperature T_{S}, i.e., the temperature at the first reference surface;
static pressure P_{w}
of the model around which air flows are required. The relations for the calculation are represented below:

$$τ w = μ \frac{ⅆ u}{ⅆ y} \qquad ( 1 )$$

where μ denotes the dynamic viscosity. With q_{w} denoting the heat flow at a point of the surface 1 or the surfaces F1, F2, and λ_{G} denoting the heat conductivity of the gas used as the flow medium, and the gas temperature T, the following applies:

$${q}_{w} = - {λ}_{G} \cdot \frac{ⅆ T}{ⅆ y} \qquad ( 2 )$$

From (2) and (3) it follows that

$$\begin{matrix}{τ}_{w} \approx \frac{μ}{{λ}_{G}} \cdot {q}_{w} \cdot \frac{ⅆ u}{ⅆ T} & ( 3 ) \\ where \frac{μ}{{λ}_{G}} = \frac{μ \cdot {ρ}_{G} \cdot {c}_{PG}}{{λ}_{G} \cdot {ρ}_{G} \cdot {c}_{PG}} = \frac{Pr}{{c}_{PG}} & ( 4 )\end{matrix}$$

The symbol C_{PG} denominates the specific heat capacity of the gas used as flow medium.

Without friction it follows that

$$\frac{ⅆ u}{ⅆ T} = \frac{{u}_{δ} - {u}_{w}}{{T}_{δ} - {T}_{w}} \qquad ( 5 )$$

Hereby denominate:
Pr the Prandtl number;
u_{δ} the speed at the outer margin of the boundary layer;
u_{w} the speed at the surface 1 or the second reference surface F2;
T_{δ} the temperature at the outer margin of the boundary layer,
T_{w} the temperature at the surface 1 or the second reference surface F2.

With friction, taking into account that

$${u}_{w} = 0 \\ and {T}_{δ} ( 1 + r \frac{k - 1}{2} {M}_{δ}^{2} ) = {T}_{c} \qquad ( 6 )$$

it follows that

$$\frac{ⅆ u}{ⅆ T} = \frac{{u}_{δ}}{{T}_{δ} - {T}_{w}} \qquad ( 7 )$$

and thus

$$\begin{matrix}{τ}_{w} \approx \frac{Pr}{{c}_{PG}} \cdot {q}_{w} \cdot \frac{{u}_{δ}}{( {T}_{c} - {T}_{w} )} & ( 8 ) \\ where {q}_{w} = \frac{{λ}_{M}}{d} ( {T}_{w} - {T}_{s} ) & ( 9 )\end{matrix}$$

Taking into consideration that

$${h}_{w} = \frac{{q}_{w}}{( {T}_{δ} - {T}_{w} )} \qquad ( 10 )$$

it follows that

$${τ}_{w} \approx \frac{PR}{{c}_{PG}} \cdot {h}_{w} \cdot {u}_{δ} \qquad ( 11 )$$

Since the measuring method only works with a non-adiabatic model surface (T_{w}≈Tₑ), and Tₑ thus is not available from the measurement, the heat transmission coefficient is formed as follows:

$${h}_{w} = \frac{{q}_{w} ( {t}_{1} ) - {q}_{w} ( {t}_{2} )}{{T}_{w} ( {t}_{1} ) - {T}_{w} ( {t}_{2} )} \qquad ( 12 )$$

The speed at the boundary layer margin is determined from the optical pressure measurement on the model surface and from the approaching flow conditions at isentropic change of state. Because

$$\frac{ⅆ p}{ⅆ n} \approx 0 \qquad ( 13 )$$

it follows that P_{w}˜P_{δ}, and thus

$$\begin{matrix}{M}_{δ} = \sqrt{5 [ {( \frac{{P}_{0}}{{P}_{w}} )}^{\frac{2}{7}} - 1 ]} & ( 14 ) \\ {T}_{δ} = \frac{{T}_{0}}{( 1 + \frac{k - 1}{2} {M}_{δ}^{2} )} & ( 15 ) \\ {u}_{δ} = {M}_{δ} \cdot \sqrt{k \cdot R \cdot {T}_{δ}} & ( 16 )\end{matrix}$$

For linking heat flow and wall shear stress, the so-called Reynolds analogy factor s is to be taken into account, which strictly speaking, however, only applies to the flat plate or slightly curved surfaces;
τ_{w}=s·h_{w}·Pr·u_{δ}/C_{PG} (17)

Hereby denominate:
s the Reynolds analogy factor,
u_{δ} the speed at the outer margin of the boundary layer, which speed is determined via the pressure measuring method; and
h_{w} the heat transmission coefficient according to equation (12), which coefficient is determined on the basis of the infrared measurement.

Through the use of the suggested, new measuring method it is now possible to determine the local speed at the model in addition to the local heat flow and, by an extended Reynolds analogy, to metrologically determine the wall shear stresses also on three-dimensional wind tunnel models.

A prerequisite for the indirect measurement of the wall shear stresses is a heat flow from model to fluid and vice versa. In this measuring method, the heat flow is the indicator via which the indirect measurement of the wall shear stresses takes place. The wall shear stresses cannot be determined at adiabatic wall temperatures, since there is no heat flow in such cases.

The measuring layer S can be made of various materials. Silicone or polyethylene hereby come into consideration as a constituent.

In the visual radiation range (0.4-0.75 μm), the measuring layer S is largely transparent and in the infrared range (0.75-14 μm) it features radiation properties that are similar to the radiation properties of the pressure-measurement-sensitive layer S. It is decisive that the foil is thermally transparent in an IR wavelength range and absorbs heat in an IR wavelength range. This characteristic is used to radiometrically measure the temperature on the surface of the foil (T_{w}) and on the surface that is covered by the foil (Tₛ). The infrared radiation emanating from the body surface can thus be measured by the infrared measuring method provided according to the invention by the system 2, and herefrom the surface temperature can be determined, taking into account the emission ratio. Since the body is spectral-selective in the surface-sided subzone, i.e., it is radiation-absorbing in a first infrared wavelength range and radiation-transparent in a second infrared wavelength range, delimited from the first, but is embodied radiation-emittingly on the inside of the subzone, the radiation energy emanating from the outer surface of the subzone can be measured in the first and in the second wavelength range, respectively. The temperature on the outer surface of the subzone is determined according to the energy proportion in the first wavelength range, and the temperature on the inner surface of the subzone is determined according to the energy proportion in the second wavelength range. The locally existing heat flow q_{w} or its distribution can be calculated via the knowledge of the two temperature measuring values and the thickness of the surface-forming subzone as well as the material properties, here the heat conductivity λ_{M}.

Instead of the pressure measuring system 3 and the infrared measuring system 2, merely a one-channel infrared camera is used in an alternative embodiment of the invention, together with a pressure-measurement-sensitive layer S, which is locally covered by a maximum-radiation IR paint. From the IR radiation of the nearly identical boundary location of transparent pressure-measurement-sensitive layer S and emitting IR paint then results the temperature difference, which determines the heat flow and is calculated by the processor unit. Hereby, at least two different filters can be used on the camera, so that in the respective measuring areas, the radiation in the visual radiation range (0.4-0.75 μm), for which radiation the measuring layer S is largely transparent and the radiation in the infrared range (0.75-14 μm) can be recorded with the first filter, together with the radiation of the pressure-measurement-sensitive layer S with the second filter.

Thus it is also possible to check the suggested measuring method, together with the pressures from the optical pressure measurement, by largely conventional devices.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A method for determining a wall shear stress distribution on a surface of a body around which air flows, the method comprising:
determining a heat flow distribution into the surface of the body around which air flows by infrared thermography;
obtaining a surface pressure distribution on the surface optically; and
determining the wall shear stress distribution on the surface of the body by processing from at least the heat flow distribution and the surface pressure distribution.

2. The method according to claim 1, wherein determining the heat flow distribution includes determining the heat flow distribution with an infrared system, and wherein determining the wall shear stress distribution includes determining the wall shear stress distribution with a processor.

3. The method according to claim 1, wherein recording a surface pressure distribution includes determining a surface pressure distribution by an optical pressure measuring technique with a PSP system, and wherein determining the wall shear stress distribution includes determining the wall shear stress distribution with a processor.

4. The method according to claim 1, wherein the heat flow distribution and the surface pressure distribution are determined one of concurrently and consecutively.

5. The method according to claim 1, wherein determining the heat flow distribution includes determining the heat flow distribution with an infrared system; and recording a surface pressure distribution includes determining a surface pressure distribution with a PSP system.

6. A device that determines a wall shear stress distribution on a surface of a body around which air flows with a PSP system and an IR system according to the method of claim 5, wherein a surface pressure distribution on the surface of the body around which air flows is determined with the PSP system and the temperature distribution on the surface is determined with the IR system one of simultaneously and consecutively.

7. A device that determines a wall shear stress distribution on a surface of a body around which air flows with a PSP system and an IR system according to the method of claim 1.

8. A device for determining a wall shear stress distribution on a surface of a body around which air flows, the device comprising:
a PSP system that determines a surface pressure distribution on the surface of the body around which air flows;
an IR system that determines a temperature distribution on the surface of the body, the IR system, having a filter, structured and arranged to record the temperature distribution in at least two different spectral emission ranges;
a synchronizer that controls the timing of data recording of the PSP system and the IR system; and
a processor that determines a current distribution of a local speed of a fluid or wall shear stress at the surface of the body.

9. The device according to claim 8, wherein the surface pressure distribution on the surface of the body around which air flows is determined with the PSP system and the temperature distribution on the surface is determined with the IR system one of simultaneously and consecutively.

10. A method for determining an aerodynamic wall shear stress in a measuring zone of a surface of a body around which a flow medium flows, the method comprising:
determining a first temperature on the surface of a measuring layer and a second temperature on a surface covered by the measuring layer;
determining a distribution of a heat flow qw over the measuring zone on a basis of the first and second temperatures, a thickness of the measuring zone, and a heat conductivity λ_{M} of the measuring layer;
determining a surface pressure distribution and, therefrom, determining a speed of the flow medium at a margin of a boundary layer by a pressure-measurement camera system utilizing a pressure sensitivity of the measuring layer; and
determining the aerodynamic wall shear stress in the measuring zone via a calculation method on the basis of the Reynolds analogy.

11. The method according to claim 10 wherein the measuring layer is arranged in an area of the measuring zone, the layer being thermally transparent in a first IR wavelength range and absorbs heat in a second IR wavelength range,
wherein the first temperature and the second temperature are radiometrically measurable by an infrared-camera measuring system.

12. The method according to claim 10 wherein the measuring layer is pressure-sensitive.

13. A device that determines a wall shear stress distribution on a surface of a body around which air flows with a PSP system and an IR system according to the method of claim 10.
